(19) United States
(12) Patent Application Publication
(10) Pub. No.: US 2017/0086623 A1
(43) Pub. Date: Mar. 30, 2017

(54) FOOD BLENDER WITH SAFETY PROTECTION MECHANISM

(71) Applicant: Wen-Ching LEE, TAICHUNG CITY (TW)

(72) Inventor: Wen-Ching LEE, TAICHUNG CITY (TW)

(21) Appl. No.: 15/261,222

(22) Filed: Sep. 9, 2016

(30) Foreign Application Priority Data
Sep. 28, 2015 (CN) 201510627000.9

(51) Int. Cl. A47J 43/07; B01F 15/00; A47J 43/046; B01F 13/08

(52) U.S. Cl. CPC A47J 43/0766; B01F 13/0827; B01F 15/00409; B01F 15/00538; A47J 43/0465; B01F 2215/0014

(57) ABSTRACT

A food blender includes a blender base including a housing defining therein a connecting seat, a connector mounted in the housing, a plurality of sensing elements mounted in the housing near the connecting seat and a driving device fixedly mounted in the housing and coupled with the connector and the sensing elements, and a food container detachably mountable in the connecting seat of the housing and having a stirrer and a plurality of magnetic members mounted in a container body thereof. The driving device controls the operation of the stirrer according to the number of the magnetic members actually detected by the sensing elements.

### BACKGROUND OF THE INVENTION

1. Field of the Invention

The present invention relates to food blender technology and More particularly to a food blender with a safety protection mechanism.

2. Description of the Related Art

When using a food blender, put food in the food container, and then attach the food container to the blender base of the food blender, and then switch on the power switch of the blender base, causing rotation of the stirrer in the food container to mince food. During the mincing process, if the mincing time is long, continuous crushing between food ingredients and the stirrer can cause generation of heat, resulting in an increase in temperature and pressure in the food container.

More particularly, for the sake of ease of storage, some commercial food blenders use a small capacity food container. Increased temperature and pressure in a food container due to a long mincing time can cause the food container to explore.

### SUMMARY OF THE INVENTION

The present invention has been accomplished under the circumstances in view. It is therefore the main object of the present invention to provide a food blender, which provides a safety protection mechanism. It is another object of the present invention to provide a food blender, which provides multiple operation modes to fit different capacities of food containers, avoiding food container explosion due to an excessively prolonged operation.

To achieve these and other objects of the present invention, a food blender comprises a blender base and a food container. The blender base comprises a housing, a connector, a plurality: of sensing elements and a driving device. The housing comprises a connecting seat. The connector is mounted in the housing. The sensing elements are respectively mounted in the housing near the connecting seat. The driving device is fixedly mounted in the housing, and coupled with the connector and the sensing elements. The food container is detachably mountable in the connecting seat of the housing. The food container comprises a container body a stirrer and a plurality of magnetic members. The stirrer is mounted in the container body. The magnetic members are mounted in the container body. The driving device controls the operation of the stirrer according to the number of the magnetic members actually detected by the sensing element.

To achieve these and other objects of the present invention, the invention provides an alternate form of the food blender. According to this alternate form, the food blender comprises a blender base, a first food container and a second food container. The blender base comprises a housing, a connector, a plurality of sensing elements and a driving device. The housing comprises a connecting seat. The connector is mounted in the housing. The sensing elements are respectively mounted in the housing near the connecting seat. The driving device is fixedly mounted in the housing, and coupled with the connector and the sensing elements. Further, the driving device provides a first operation mode and a second operation mode. The operating time of the second operation mode is shorter than the operating time of the first operation mode. The first food container is detachably mountable in the connecting seat of the housing. The first food container comprises a first container body, a first stirrer and a plurality of first magnetic members. The first stirrer is mounted in the first container body. The first magnetic members are mounted in the first container body. The second food container is detachably mountable in the connecting seat of the housing. The second food container comprises a second container body, a second stirrer and a plurality of second magnetic members. The second stirrer is mounted in the second container body. The second magnetic members are mounted in the second container body. The capacity of the second food container is smaller than the capacity of the first food container. The number of the first magnetic members is different from the number of the second magnetic members. When the sensing elements detect the number of the first magnetic members, the driving device selects the first operation mode, and controls the first stirrer to operate according to the first operation mode. When the sensing elements detect the number of the second magnetic members, the driving device selects the second operation mode, and controls the second stirrer to operate according to the second operation mode.

Thus, the blender base of the food blender provides a respective operating mode according to the number of the magnetic members actually detected by the sensing elements, avoiding the danger of food container explosion due to an excessively prolonged operation.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a food blender in accordance with the present invention.

FIG. 2 is a sectional elevation of the food blender shown in FIG. 1.

FIG. 3 is a circuit block diagram of the connector, control button, three sensing elements and driving device of the food blender in accordance with the present invention.

FIG. 4 is a sectional view of the present Invention, illustrating the blender base and the food container connected together.

### DETAILED DESCRIPTION OF THE INVENTION

A preferred embodiment of a food blender in accordance with the present invention is described hereinafter in conjunction with the annexed drawings. However, the components, dimension and outer appearance illustrated in the annexed drawings are simply for illustration purpose only but not intended to limit the technical features of the present invention.

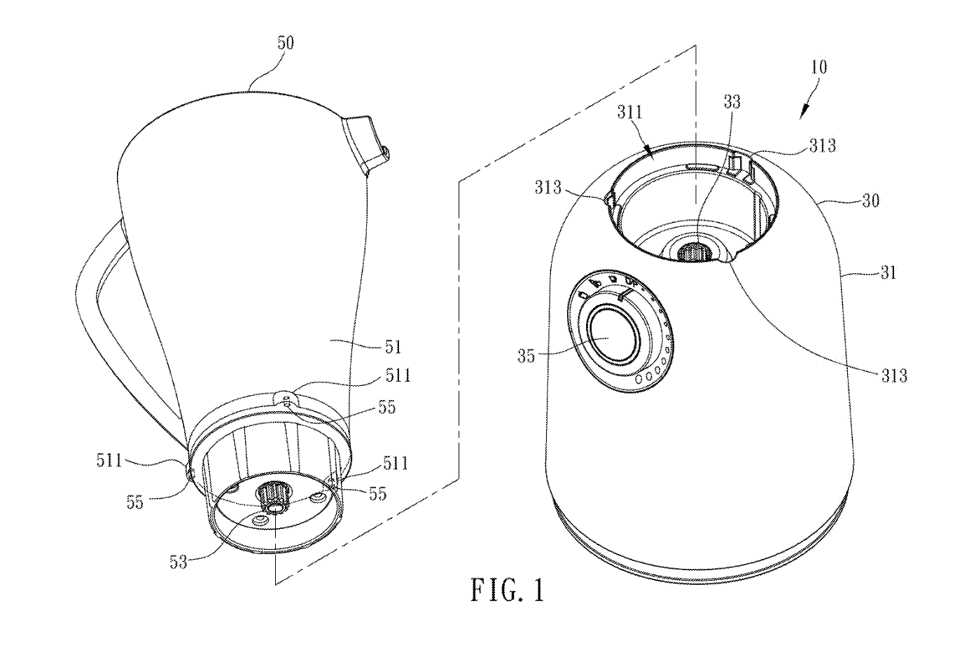

Referring to FIG. 1, a food blender 10 generally comprises a blender base 30 and a food container 50. The blender base 30 of the food blender 10 comprises a housing 31, a connector 33 and a control button 35. The housing 31 comprises a connecting seat 311 and three positioning grooves 313 located on an inner perimeter of the connecting seat 311. The connector 33 is mounted in the housing 31, and disposed inside the connecting seat 311. The control button 35 is mounted on the housing 31.

The food container 50 comprises a container body 51, a stirrer 53 and three magnetic members 55. The container body 51 comprises three protruded portions 511. The stirrer is mounted in the container body 51, and rotatable relative to the container body 51. The three magnetic members 55 are respectively mounted in the three protruded portion 511 of the container body 51. Further, these three magnetic members 55 are permanent magnets.

The three protruded portions 511 of the container body 51 are respectively aimed at the three positioning grooves 313 in the housing 31 of the blender base 30. When the food container 50 and the blender base 30 are assembled, the three protruded portions 511 of the container body 51 are respectively engaged in the three positioning grooves 313 of the housing 31, and the stirrer 53 is connected to the connector 33. The structure of the stirrer 53 and the connector 33 and their connection are of the known art, therefore we do not repeat them here.

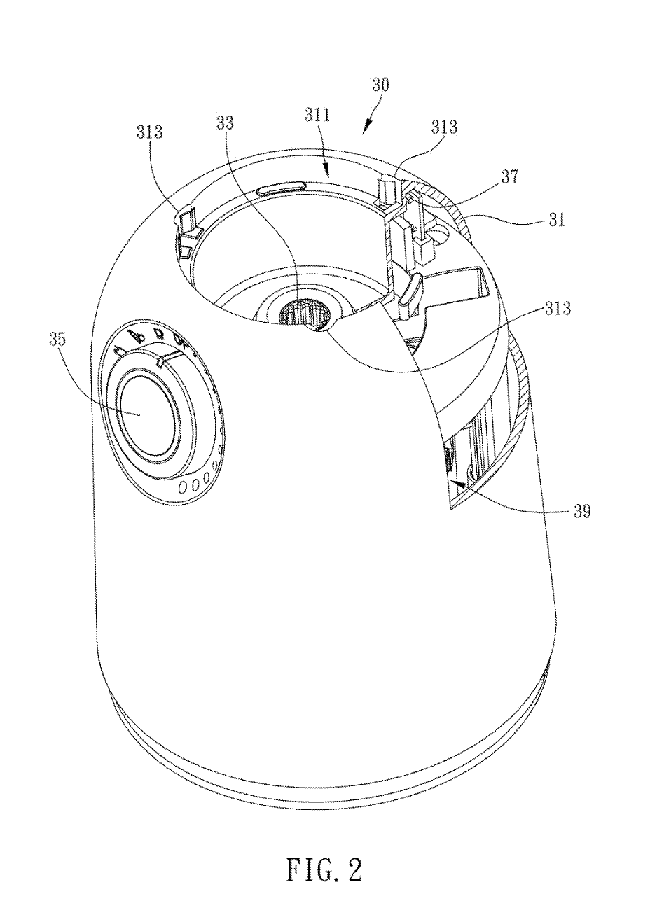

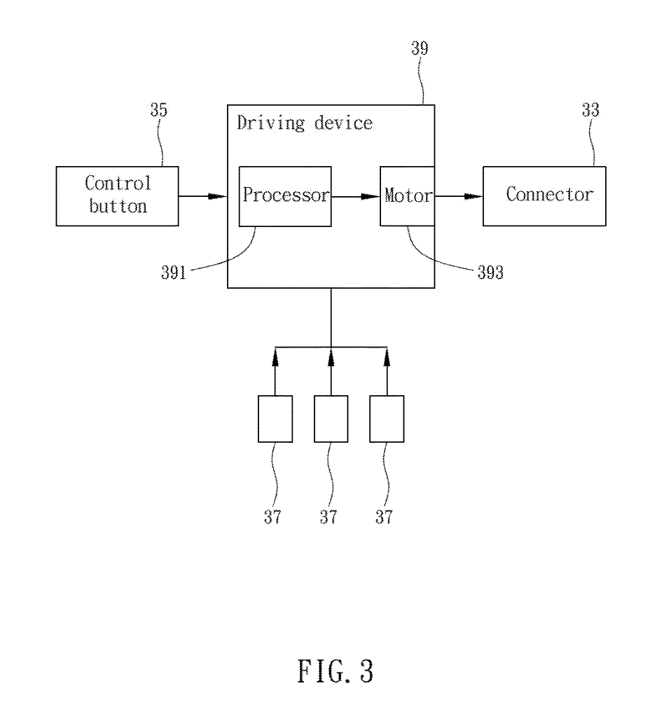

Referring to FIGS. 2 and 3, where FIG. 2 is a sectional elevational view of the blender base 30; FIG. 3 is a block diagram of the connector 33, the control button 35, three sensing elements 37 and a driving device 39. The blender base 30 further comprises three sensing elements 37 and a driving device 39. The sensing elements 37 are respectively fixedly mounted in the housing 31 near the connecting seat 311. The driving device 39 is mounted inside the housing 31, and coupled with the connector 33, the control button 35 and the sensing elements 37. The control button 35 is adapted for controlling the driving device 39 to rotate the connector 33, for example, adjusting he revolving speed. How the control button 35 controls the driving device 39 is a common knowledge in the art, therefore we do not repeat them here.

In the present preferred embodiment, these sensing elements 37 are mounted inside the housing 31, and respectively disposed adjacent to the three positioning grooves 313 in the housing 31. The sensing elements 37 can be, for example, Hall-effect sensors.

The driving device 39 comprises a processor 391 and a motor 393. The processor 391 has multiple operation modes. These operation modes are configured to control the operating time of the motor 393. Every operation mode controls the motor 391 to operate at a different operating time. The selection of these operation modes has a great concern with the sensing elements 37. This operation will be explained later.

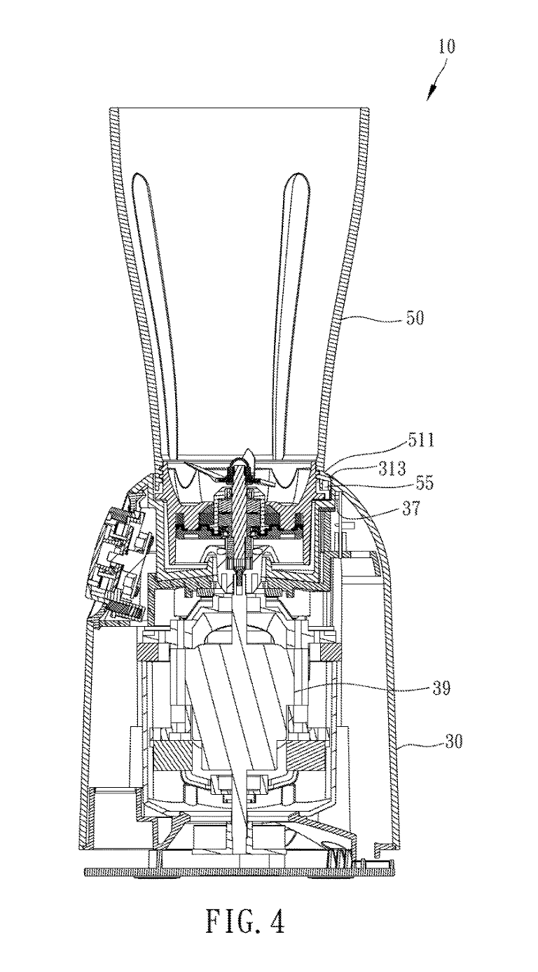

FIG. 4 is a schematic sectional view illustrating the blender base 30 and the food container 50 mounted together. As illustrated, the sensing elements 37 are adapted for sensing the magnetic fields of the respective magnetic members 55, and then converting the detected magnetic fields into respective electrical signals (for example, voltage or current signals) for analysis by the processor 391 of the driving device 39. The processor 391 can select a corresponding operation mode.

In the present preferred embodiment, the driving device provides three operation modes (the first operation mode, the second operation mode and the third operation mode) corresponding to three different capacities of food containers, for example, the first (large) food container, the second (medium) food container and the third (small) food container. Therefore, different capacities of food containers have a different number of magnetic members mounted therein. For example, the first, second and third food containers have different capacities and respectively have three magnetic members, two magnetic members and one magnetic member mounted therein. Although the first, second and third food containers have different capacities, they have the same connection structure for connection to the connecting seat of the blender base as previously described.

If the first food container is mounted in the connecting seat of the blender base, the sensing elements of the blender base will detect the presence of the magnetic fields of three magnetic members. Thus, the processor will select the corresponding first operation mode according to the number of three magnetic members. Further; because the first food container has the largest capacity, the motor operating time of this first operation mode is the longest operating time.

If the second food container is mounted in the connecting seat of the blender base, the sensing elements of the blender base will detect the presence of the magnetic fields of two magnetic members. Thus, the processor will select the corresponding second operation mode according to the number of two magnetic members. Further, because the second food container has the medium capacity, the motor operating time of this second operation mode is shorter than the motor operating time of the first operation mode.

If the third food container is mounted in the connecting seat of the blender base, the sensing elements of the blender base will detect the presence of the magnetic field of one single magnetic member. Thus, the processor will select the corresponding third operation mode according to the number of one single magnetic member. Further, because the third food container has the smallest capacity, the motor operating time of this third operation mode is shorter than the motor operating time of the first operation mode and the motor operating time of the second operation mode. Thus, the food blender of the present invention an select a corresponding operation mode subject to the number of magnetic members. Therefore, food containers of different capacities can be operated under a respective appropriate operation mode, avoiding the danger of food container explosion due to an excessively prolonged operation.

Further, the number of the food containers, the sensing elements and the magnetic members is not limited to three. They can be more than three. Further the arrangement of the sensing elements and the magnetic members is not limited to that illustrated in the annexed drawings. Further, in the present preferred embodiment, three different capacities of food containers are selected for explanation of the technical features of the present invention, however, in actual practice, the selection of different operation modes can be defined according to the function and access authority of the food containers, therefore, the operation mode corresponding to the container capacity is not a limitation.

In the present preferred embodiment, the processor selects the appropriate operation mode according to the actual number of magnetic member detected by the sensing element. However, in actual application, the selection of the operation modes can be achieved through mechanical switch means or any other measures. Thus, the processor simply needs to determine whether or not the selected operation mode is consistent with the number of magnetic members actually detected by the sensing elements. If matched, the processor of the blender base controls the motor to rotate. If not matched, the processor controls the motor not to rotate. Thus, this measure is also within the range of protection of the present invention, achieving the safety protection according to the number of sensing elements and magnetic members.

Although a particular embodiment of the invention has been described in detail for purposes of illustration, various modifications and enhancements may he made without departing from the spirit and scope of the invention. Accordingly, the invention not to be limited except as by the appended claims.

What is claimed is:

1. A food blender, comprising:
blender base comprising a housing, a connector, a plurality of sensing elements and a driving device, said housing comprising a connecting seat, said connector being mounted in said housing, said sensing elements being respectively mounted in said housing near said connecting seat, said driving device being fixedly mounted in said housing and coupled with said connector and said sensing elements; and
a food container detachably mountable in said connecting seat of said housing, said food container comprising a container body, a stirrer and a plurality of magnetic members, said stirrer being mounted in said container both, said magnetic members being mounted in said container body, wherein said driving device is capable of controlling the operation of said stirrer according to the number of said magnetic members being detected by the respective said sensing elements.

2. The food blender as claimed in claim 1, wherein said sensing elements are disposed inside said housing.

3. The food blender as claimed in claim 1, wherein said driving device comprises a processor and a motor, said processor being adapted for controlling the operating time of said motor according to the number of said magnetic members actually detected by said sensing elements, said motor being coupled to said processor and controlled by said processor to rotate said stirrer.

4. The food blender as claimed in claim 3, wherein said processor provides a plurality of operation modes for controlling said motor to operate at a respective period of operating time, said processor of said blender base selecting one said operation mode according the number of said magnetic members actually detected by said sensing elements.

5. The food blender as claimed in claim 1, wherein said housing of said blender base fir comprises a plurality of positioning grooves located in an inner perimeter of said connecting seat; said sensing elements are respectively disposed adjacent to one respective said positioning grooves; said container body of said food container comprises a plurality of protruded portions respectively disposed corresponding to one respective said positioning grooves; said magnetic members are respectively mounted in one respective said protruded portion.

6. The food blender as claimed in claim 1, wherein said magnetic members are permanent magnets.

7. A food blender, comprising:
a blender base comprising a housing, a connector, a plurality of sensing elements and a driving device, said housing comprising a connecting seat, said connector being mounted in said housing, said sensing elements being respectively mounted in said housing near said connecting seat, said driving device being fixedly mounted in said housing and coupled with said connector and said sensing elements and providing a first operation mode and a second operation mode, the operating time of said second operation mode being shorten than the operating time of said first operation mode;
a first food container detachably mountable in said connecting seat of said housing, said first food container comprising a first container body, a first stirrer and a plurality of first magnetic members, said first stirrer being mounted in said first container body, said first magnetic members being mounted in said first container body; and
a second food container detachably mountable in said connecting seat of said housing, said second food container comprising a second container body, a second stirrer and a plurality of second magnetic members, said second stirrer being mounted in said second container body, said second magnetic members being mounted in said second container body;
wherein the number of said first magnetic members is different from the number of said second magnetic members; said driving device is configured to select said first operation mode and to control the operation of said first stirrer according to said first operation mode when said sensing elements detected the number of said first magnetic members, or to select said second operation mode and to control the operation of said second stirrer according to said second operation mode when said sensing elements detected the number of said second magnetic members.

8. The food blender as claimed in claim 7, wherein said driving device comprises a processor and a motor, said processor being adapted selecting one of said first operation mode and said second operation mode according to the number of said first magnetic members or said second magnetic members that are actually detected by said sensing elements, said motor being coupled to said processor and controlled by said processor to rotate said first stirrer or said second stirrer according to the one of the said first operation mode and said second operation mode that is selected by said processor.

9. The food blender as claimed in claim 7, wherein said sensing elements are disposed inside said housing.

10. The food blender as claimed in claim 7, wherein said housing of said blender base further comprises a plurality of positioning grooves located in an inner perimeter of said connecting seat; said sensing elements are respectively disposed adjacent to one respective said positioning grooves; said first container body of said first food container and said second container body of said second food container each comprise a plurality of protruded portions respectively disposed corresponding to one respective said positioning grooves; said first magnetic members are respectively mounted in one respective said protruded portion of said first food container; said second magnetic members are respectively mounted in one respective said protruded portion of said second food container.
